(19) United States
(12) Patent Application Publication
(10) Pub. No.: US 2015/0171570 A1
(43) Pub. Date: Jun. 18, 2015

(54) CONNECTION PORT SOCKET STRUCTURE

(71) Applicant: ASIAN POWER DEVICES INC., Taoyuan County (TW)

(72) Inventor: Ming-Cheng LEE, Taoyuan County (TW)

(21) Appl. No.: 14/326,363

(22) Filed: Jul. 8, 2014

(30) Foreign Application Priority Data
Dec. 13, 2013 (TW) 102146326

(51) Int. Cl. H01R 13/703; H02J 7/00; H01R 13/04

(52) U.S. Cl. CPC H01R 13/7031; H01R 13/04; H02J 7/0029

(57) ABSTRACT

A cutter used for cutting sheet material includes a cutting board, a knife rack and two pairs of knife wheels. The cutting board allows the sheet material to be laid on and has a guiding track. The knife rack is arranged on the cutting board and is able to slide along with the guiding track. One inner side of the knife rack near the guiding track is provided with two pairs of knife grooves, and two guiding grooves are provided on the knife rack between the two pairs of knife grooves respectively, and the two guiding grooves are used to guide the cut sheet material to leave. The two knife wheels are installed inside the upper and lower pairs of knife grooves of the knife rack.

### BACKGROUND

1. Technical Field

This present invention relates to a connection port socket structure, particularly to a connection port socket structure which is able to be used as a control circuit.

2. Related Art

Due to the trend of lightweight and thin electrical devices, users are getting used to carrying these electrical devices. The most common electrical devices, like the mobile phone, PDA, portable computer, tablet computer, digital camera, or digital cam recorder, have been commonly used by consumers around the world, and become an essential part of the modern life.

The aforementioned electrical devices have been carry-on products for users nowadays. Since those electrical devices are continuously used for a very long time, which drains the battery very quickly, the demand of fast charging has become noticeable to the market. For now, there are numerous charging voltages of the electrical devices on the market, the voltages ranging from 3.3 V to 12V. Eventually, the voltage adjustable charging products have also been released to the market. However, damage to an electrical device can happen if the consumers accidentally connect the none-high voltage resistant electrical devices to a high voltage charging device.

### BRIEF SUMMARY

The present invention provides a connection port socket structure which connects to a charging circuit or boost and buck circuits. When the connection port socket structure is disconnected from the connection port plug structure, the voltage of the charging circuit or the boost and buck circuits can be immediately adjusted.

The present invention provides a connection port socket structure that includes a plurality of pins, and at least two pins have a switch interface provided therebetween. By this arrangement, the charging and discharging circuits, boost and buck circuits, or any other startup circuits can easily protect the uncharged device and circuit controlling by using the connection port socket structure with a switch interface.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a preferred embodiment according to the present invention;

FIG. 2 is a first schematic application diagram of a first preferred embodiment according to the present invention;

FIG. 3 is a second schematic application diagram of the first preferred embodiment according to the present invention;

FIG. 4 is a first schematic application diagram of a second preferred embodiment according to the present invention;

FIG. 5 is a second schematic application diagram of the second preferred embodiment according to the present invention;

FIG. 6 is a first schematic application diagram of a third preferred embodiment according to the present invention; and

FIG. 7 is a second schematic application diagram of the third preferred embodiment according to the present invention.

### DETAILED DESCRIPTION

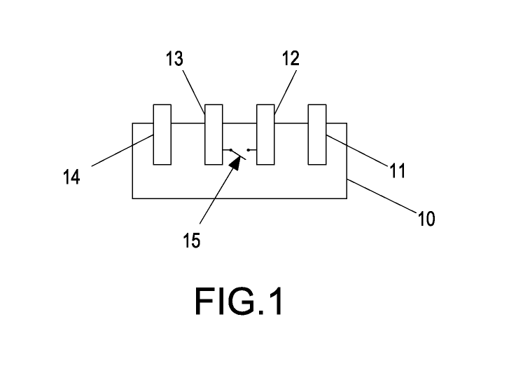

Please refer to FIG. 1, the connection port socket structure 10 can have a plurality of pins. In this preferred embodiment, there are 4 pins in the connection port structure 10, but not limited thereto. The four pins are respectively defined as a first pin 11, a second pin 12, a third pin 13, and a fourth pin 14. At least two pins of these four pins have a switch interface 15 provided therebetween. However, the switch interface 15 can be provided between any two of the four pins. In this preferred embodiment, one switch interface 15 is provided between the second pin 12 and the third pin 13, but not limited thereto. The connection port socket structure 10 can be a USB socket structure, a micro USB socket structure or any other equivalent structures which can transfer electricity or signal.

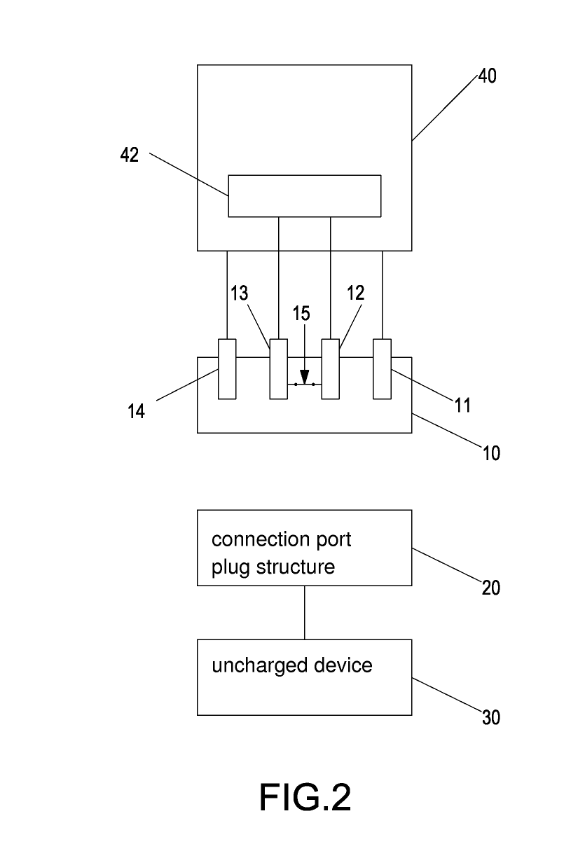

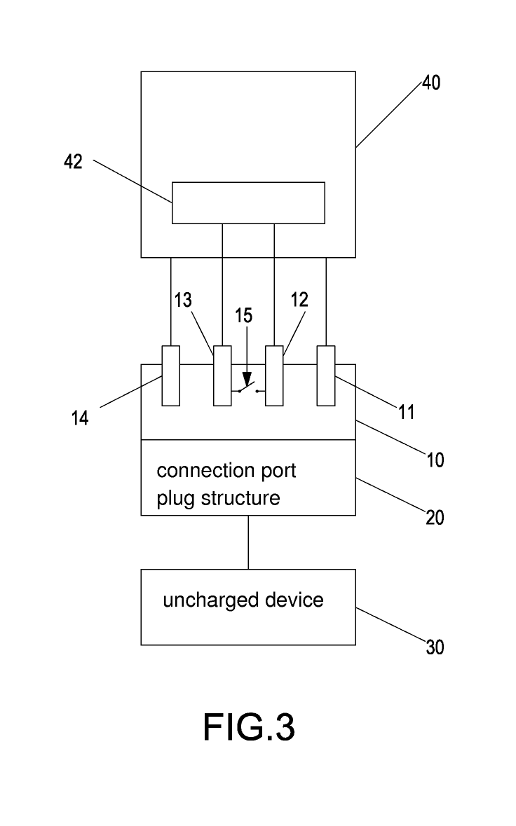

Please refer to FIGS. 2 and 3, which are the first preferred embodiment of the present invention. The connection port socket structure 10 can connect or disconnect with a connection port plug structure 20. When the connection port socket structure 10 disconnects with the connection port plug structure 20, the switch interface 15 is in a first state. In the present embodiment, the first state is in a conduction status. When the connection port socket structure 10 connects with the connection port plug structure 20, the switch interface 15 is in a second state. In the present embodiment, the second state is in an open circuit status. The connection port plug structure 20 can be a USB plug structure, micro USB plug structure or any other equivalent structures which can transfer electricity or signal.

The present embodiment can further connect to a charging circuit 40. The charging circuit 40 has a buck unit 42, and the buck unit 42 couples to the switch interface 15. When the buck unit 42 is in an operating status, the charging circuit 40 can provide an initial voltage value. Therefore, when the connection port socket structure 10 connects with the connection port plug structure 20, the switch interface 15 is in a second state (open circuit), thereby preventing the buck unit 42 from working. Meanwhile, the charging circuit 40 can transfer the electricity to an uncharged device 30 which connects to the connection port plug structure 20. The uncharged device 30 can transfer a signal to the charging circuit 40 to increase the initial voltage to a charging voltage of the uncharged device 30.

When the connection port socket structure 10 disconnects with the connection port plug structure 20, the switch interface 15 is in a first state (conduction status), thereby enabling the buck unit 42 to work, and the increased voltage of the charging circuit 40 can be decreased to the initial voltage. If there is another uncharged device which has lower voltage resistance than the previously increased voltage of the charging circuit 40, the uncharged device might be damaged due to the high charging voltage. Thus, the arrangement of the connection port socket structure 10 and the charging circuit 40 can form a protection device to the charging device.

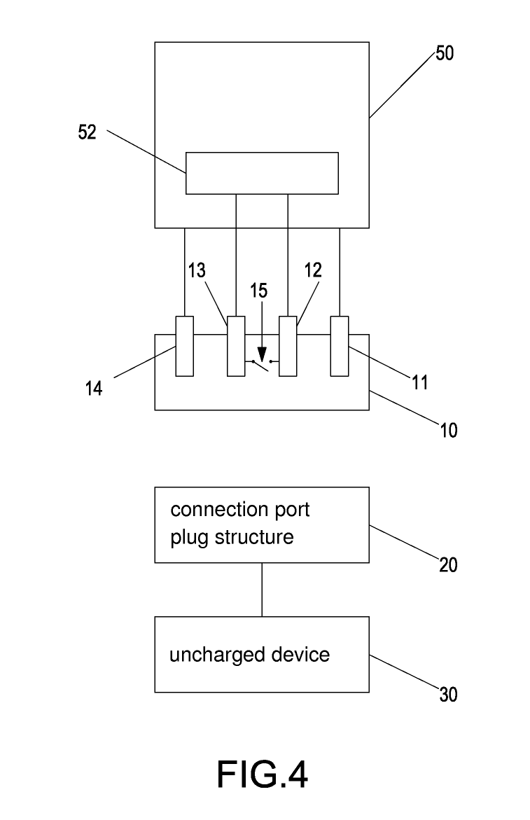

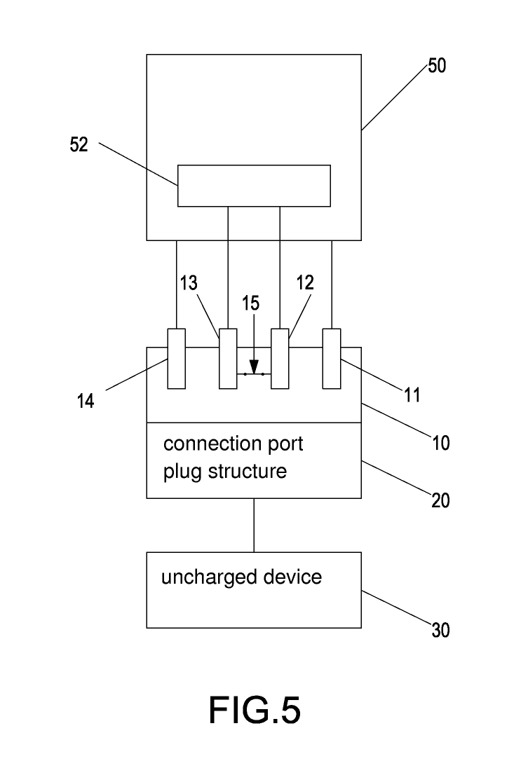

Please refer to FIGS. 4 and 5, which are the second preferred embodiment of the present invention. The difference of the present embodiment compared with the previous embodiment is that the first state in the present embodiment is in an open circuit status, and the second state is in a conduction status.

The present embodiment, the connection port socket structure 10 can connect to a boost circuit 50. The boost circuit 50 has a voltage control unit 52. The voltage control unit 52 couples to the switch interface 15. When the voltage control unit 52 is not in a working condition, the boost circuit 50 can provide an initial voltage. When the voltage control unit 52 is in a working condition, the boost circuit 50 can provide a voltage higher than the initial voltage. Therefore, when the connection port socket structure 10 connects with the connection port plug structure 20, the switch interface 15 is in a second state (conduction status), and the voltage control unit 52 can increase the initial voltage of the boost circuit 50 to a higher voltage. By doing so, the uncharged device 30 which connects to the connection port plug structure 20 will not fail to obtain a desired voltage due to the voltage drop between the two different wires.

When the connection port socket structure 10 disconnects with the connection port plug structure 20, the switch interface 15 is in a first state (open circuit status), and the voltage control unit 52 will not be able to work, thereby decreasing the voltage of the boost circuit 50 to the initial voltage.

Furthermore, the connection port socket structure 10 according to the present invention can connect to a buck circuit (not shown in the FIG.) by the circuit design, or the first state can be changed to conduction status, and the second state can be changed to open circuit status, so as to protect the uncharged device.

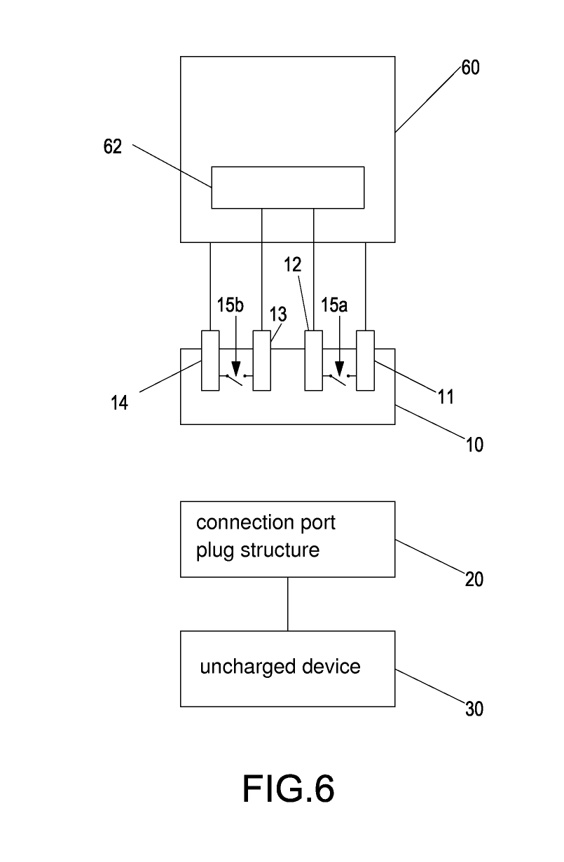

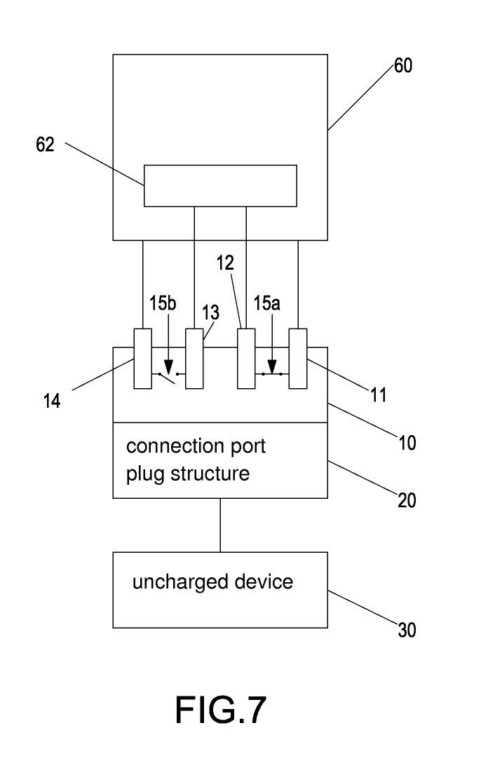

Please refer to FIGS. 6 and 7, which are the third preferred embodiment of the present invention. The connection port socket structure 10 can have a plurality of pins. In this preferred embodiment, there are 4 pins in the connection port structure 10, but not limited thereto. The four pins are respectively defined as a first pin 11, a second pin 12, a third pin 13, and a fourth pin 14. The switch interface 15 can be provided between any two of the four pins. In the present embodiment, the connection port socket structure 10 has two switch interfaces 15a, 15b. The switch interface 15a is provided between the first pin 11 and the second pin 12, and the switch interface 15b is provided between the third pin 13 and the fourth pin 14, but not limited thereto.

When the connection port socket structure 10 disconnects with the connection port plug structure 20, the two switch interfaces 15a, 15b are in a first state (open circuit status); By contrast, when the connection port socket structure 10 connects with the connection port plug structure 20, one of the two switch interfaces 15a, 15b can be in a second state (conduction status) by the design of the connection port plug structure 20.

The connection port socket structure 10 of the present embodiment can also connect to a boost/buck circuit 60, and the boost/buck circuit 60 has a voltage control unit 62 coupling to the two switch interfaces 15a, 15b. When the connection port socket structure 10 connects with the connection port plug structure 20, one of the two switch interfaces 15a, 15b can be in a second state (conduction status) by the design of the connection port plug structure 20. By this arrangement, the voltage control unit 62 will decide increasing the initial voltage of the boost/buck circuit 60 to a higher voltage or decreasing the voltage to a lower voltage.

By contrast, when the connection port socket structure 10 disconnects with the connection port plug structure 20, the two switch interfaces 15a, 15b are in a first state (open circuit status), and the voltage control unit 52 is not able to work, thereby decreasing the voltage of the boost/buck circuit 60 to the initial voltage.

By the design of the circuit, the connection port socket structure 10 according to the third embodiment of the present invention can change the first state to be conduction status, and the second state can also be changed to open circuit status. For example, when the connection port socket structure 10 connects with the connection port plug structure 20, one of the two switch interfaces 15a, 15b can be in a second state (open circuit status), and the other one of the two switch interfaces 15a, 15b can be in a first state (conduction status) by the design of the connection port plug structure 20, thereby deciding the voltage of the boost/buck circuit 60. By this arrangement, the goal of protecting the uncharged device 30 can be achieved.

Although the present invention has been described with reference to the foregoing preferred embodiments, it will be understood that the invention is not limited to the details thereof Various equivalent variations and modifications can still occur to those skilled in this art in view of the teachings of the present invention. Thus, all such variations and equivalent modifications are also embraced within the scope of the invention as defined in the appended claims.

What is claimed is:

1. A connection port socket structure comprising a plurality of pins, wherein at least two pins have a switch interface provided therebetween.

2. The connection port socket structure according to claim 1, wherein the connection port socket structure connects or disconnects with a connection port plug structure.

3. The connection port socket structure according to claim 2, wherein the connection port socket structure is a USB socket structure or a micro USB socket structure.

4. The connection port socket structure according to claim 3, wherein the connection port plug structure is a USB plug structure or a micro USB plug structure.

5. The connection port socket structure according to claim 4, wherein when the connection port socket structure disconnects with the connection port plug structure, the switch interface is in a first state; when the connection port socket structure connects with the connection port plug structure, the switch interface is in a second state.

6. The connection port socket structure according to claim 5, wherein the connection port socket structure connects to a charging circuit, and a buck unit of the charging circuit couples to the switch interface.

7. The connection port socket structure according to claim 6, wherein the first state is in a conduction status, and the second state is in an open circuit status.

8. The connection port socket structure according to claim 5, wherein the connection port socket structure connects to a boost circuit, and a voltage control unit of the boost circuit couples to the switch interface.

9. The connection port socket structure according to claim 5, wherein the connection port socket structure connects to a boost/buck circuit, and a voltage control unit of the boost/buck circuit couples to the switch interface.

10. The connection port socket structure according to claim 8, wherein the first state is in an open circuit status, and the second state is in a conduction status.

11. The connection port socket structure according to claim 9, wherein the first state is in an open circuit status, and the second state is in a conduction status.
